(19) United States
(12) Patent Application Publication
(10) Pub. No.: US 2008/0069036 A1
(43) Pub. Date: Mar. 20, 2008

(54) Method for implementing clear channel assessment function in wireless mesh network and mobile terminal thereof

(75) Inventors: Sung-Won Lee, Yongin-si (KR); Jun-Seo Lee, Yongin-si (KR); Rakesh Taori, Yongin-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/790,551

(22) Filed: Apr. 26, 2007

Related U.S. Application Data
(60) Provisional application No. 60/844,648, filed on Sep. 15, 2006.

(30) Foreign Application Priority Data
Dec. 6, 2006 (KR) 10-2006-0123337

(51) Int. Cl. H04L 12/26; H04Q 7/00

(52) U.S. Cl. 370/328; 370/241; 455/67.11

(57) ABSTRACT

A system and method are provided for performing a clear channel assessment (CCA) function in a wireless mesh network. In doing so, a method is provided for performing a CCA function to detect a hidden node in a wireless mesh network and includes varying a predetermined default threshold value according to at least one parameter, and determining a variable threshold value to perform the CCA function resulting from the varying of the predetermined default threshold value. The CCA function can then be performed based on the determined variable threshold value.

### CROSS-REFERENCE TO RELATED APPLICATIONS

This application claims the benefit under 35 U.S.C. §119(e) of U.S. Provisional Application No. 60/844,648, filed Sep. 15, 2006, in the U.S. Patent and Trademark Office, and claims the benefit under 35 U.S.C. § 119(a) of Korean Patent Application No. 10-2006-0123337, filed Dec. 6, 2006, in the Korean Intellectual Property Office, the entire disclosures of both of which are incorporated herein by reference.

### BACKGROUND OF THE INVENTION

1. Field of the Invention

The present invention relates to a wireless mesh network. More particularly, the present invention relates to a system and method for performing a clear channel assessment (CCA) function in a wireless mesh network, which can flexibly cope with a hidden node problem generated in the wireless mesh network.

2. Description of Related Art

Generally, a wireless mesh network is not a newly provided network structure. Instead, wireless mesh network technology is a technology that interoperates over various existing wireless connection technologies which are already being widely used, and provides users with a number of solutions to existing problems. Since wireless mesh network technology has the advantages of self-configuring and self-healing of an ad-hoc network, the wireless mesh network technology can quickly build a network at a lower cost. Thus wireless mesh network technology has currently become more popular.

In comparison with point-to-point communications and point-to-multipoint communications of existing wireless communications, wireless mesh network technology has the advantages of an expandability of a wireless network using a reliable network and having fewer outputs, and the like, since a wireless network also has a network structure of a wired mesh type. Further, wireless mesh network technology may be widely used in various fields such as next generation mobile communications, home networking, and special purpose networking for public safety. Various research has been performed to establish exemplary test bed environments to build an enhanced mesh network in both academic and business fields.

The wireless mesh network uses a carrier sensing function in order to determine whether a medium is available, which may be generally divided into a physical carrier sensing function and a virtual carrier sensing function. A physical layer provides the physical carrier sensing function, and the physical carrier sensing function may detect the energy of the medium, and compare the detected energy value and a predetermined threshold value, thereby determining whether the medium is available.

Also, a network allocation vector (NAV) can provide the virtual carrier sensing function, wherein the NAV corresponds to a timer indicating time information of expected time required that a medium will be in use for completing a transmission, including all frames. Specifically, the virtual carrier sensing function may dictate that the medium is available when the NAV corresponds to 0, and dictate that the medium is being used when the NAV is other than 0.

However, a conventional carrier sensing function may have a limitation when being used in a more extensive wireless network. Specifically, there are problems in that sufficient information to solve a hidden node problem may not be obtained. The hidden node problem corresponds to a problem wherein a transmitting side does not expect a collision when transmission starts, however, the collision may occur in a receiving side.

Also, establishing an accurate NAV in order to solve the hidden node problem in the conventional carrier sensing function is an important requirement, and there are problems in that some mechanisms must be severely restricted, such as power reduction, in order to meet the requirement.

Therefore, a need exists for a system and method for performing a CCA function in a wireless mesh network, which can flexibly cope with a hidden node problem generated in the wireless mesh network.

### SUMMARY OF THE INVENTION

An aspect of exemplary embodiments of the present invention is to address at least the above problems and/or disadvantages and to provide at least the advantages described below. Accordingly, an aspect of exemplary embodiments of the present invention is to provide a system and method for performing a clear channel assessment (CCA) function in a wireless mesh network in order to flexibly cope with a hidden node problem generated in the wireless mesh network, determine a variable threshold value reflecting at least one parameter, and perform the CCA function with respect to a destination channel, based on the determined variable threshold value when a common channel is switched to the destination channel.

According to an aspect of exemplary embodiments of the present invention, a CCA performance method is provided for performing a CCA function to detect a hidden node in a wireless mesh network comprising varying a predetermined default threshold value according to at least one parameter, and determining a variable threshold value to perform the CCA function resulting from the varying of the predetermined default threshold value, and performing the CCA function, based on the determined variable threshold value.

According to another aspect of exemplary embodiments of the present invention, a system is provided comprising for example, a mobile terminal, for performing a CCA function to detect a hidden node in a wireless mesh network, the mobile terminal comprising a threshold value determining unit which varies a predetermined default threshold value according to at least one parameter, and which determines a variable threshold value to perform the CCA function resulting from the varying of the predetermined default threshold value, and a CCA unit which performs the CCA function, based on the determined variable threshold value.

Other objects, advantages, and salient features of the present invention will become apparent to those skilled in the art from the following detailed description, which, taken in conjunction with the annexed drawings, discloses exemplary embodiments of the invention.

### BRIEF DESCRIPTION OF THE DRAWINGS

The above and other objects, features, and advantages of certain exemplary embodiments of the present invention will become more apparent from the following detailed description, taken in conjunction with the accompanying drawings, in which:

FIG. 1 is a configuration diagram illustrating a wireless mesh network according to an exemplary embodiment of the present invention;

FIG. 2 is a flowchart illustrating a method of performing a clear channel assessment (CCA) function in a wireless mesh network according to an exemplary embodiment of the present invention;

FIG. 3 is a diagram illustrating an operation principle of a common channel framework (CCF) mechanism according to an exemplary embodiment of the present invention;

FIG. 4 is a diagram illustrating an operation principle of performing a CCA function according to an exemplary embodiment of the present invention; and

FIG. 5 is a block diagram illustrating a mobile terminal for performing a CCA function in a wireless mesh network according to an exemplary embodiment of the present invention.

Throughout the drawings, the same drawing reference numerals will be understood to refer to the same elements, features, and structures.

### DETAILED DESCRIPTION OF EXEMPLARY EMBODIMENTS

The matters defined in the description, such as detailed construction and element descriptions, are provided to assist in a comprehensive understanding of exemplary embodiments of the present invention. Accordingly, those of ordinary skill in the art will recognize that various changes and modifications of the embodiments described herein can be made without departing from the scope and spirit of the present invention. Also, descriptions of well-known functions and constructions are omitted for clarity and conciseness.

It can be assumed for illustration purposes that a mobile terminal for performing a clear channel assessment (CCA) function according to exemplary embodiments of the present invention can be realized as any one or more of a mobile communication terminal, a public switched telephone network (PSTN) terminal, a voice over Internet protocol (VoIP) terminal, a session initiation protocol (SIP) terminal, a media gateway controller (Megaco) terminal, a personal digital assistant (PDA), a cellular phone, a personal communication service (PCS) phone, a hand-held personal computer (PC), a code division multiple access (CDMA)-2000(1×, 3×) phone, a wideband CDMA (WCDMA) phone, a dual band/dual mode phone, a global system for mobile communication (GSM) phone, a mobile broadband system (MBS) phone, a satellite/terrestrial digital multimedia broadcasting (DMB) phone, and the like.

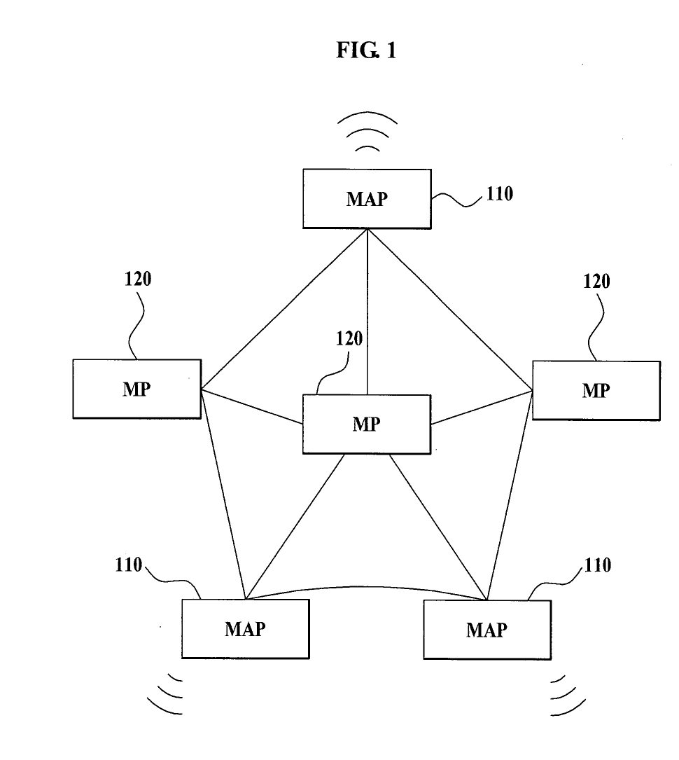

FIG. 1 is a configuration diagram illustrating a wireless mesh network according to an exemplary embodiment of the present invention.

As illustrated in FIG. 1, a wireless mesh network according to exemplary embodiments of the present invention can comprise mesh access points (MAPs) 110 and mesh points (MPs) 120 in order to have a wide service area.

Each MP 120 can wirelessly connect with at least one adjacent MP, and can relay a data frame for each hop unit, such as a router, with respect to another MP, for example, a router operating in a wired network. Specifically, the data frame transmitted by a transmitting MP can be routed to a receiving MP via at least one hop. Also, an MP which performs an access point function is referred to as a MAP.

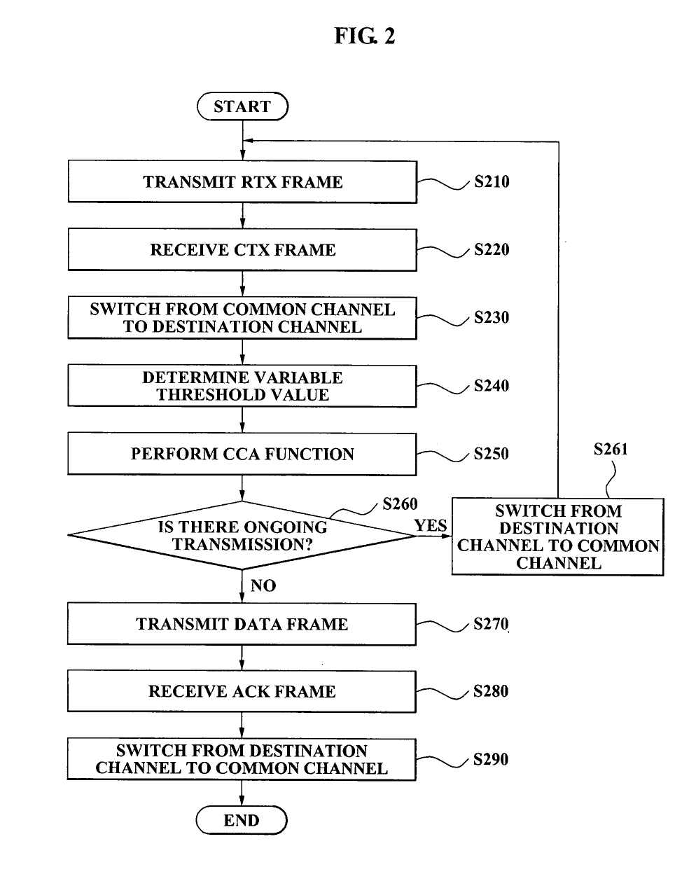

FIG. 2 is a flowchart illustrating a method of performing a CCA function in a wireless mesh network according to an exemplary embodiment of the present invention.

As illustrated in FIG. 2, a method of performing a CCA function in a wireless mesh network according to an exemplary embodiment of the present invention can comprise transmitting a request to switch (RTX) frame at step (S210), receiving a clear to switch (CTX) frame at step (S220), switching from a common channel to a destination channel at step (S230), determining a variable threshold value at step (S240), and performing the CCA function at step (S250).

Next, the method comprises determining whether there is ongoing transmission at step (S260) and if so, switching from the destination channel to the common channel at step (S261) and returning to step (S210). If not, then transmitting a data frame at step (S270), receiving an acknowledgement (ACK) frame at step (S280), and switching from the destination channel to the common channel at step (S290).

In a manner similar to the description above, a method of performing a CCA function in a wireless mesh network according to exemplary embodiments of the present invention is described in greater detail below.

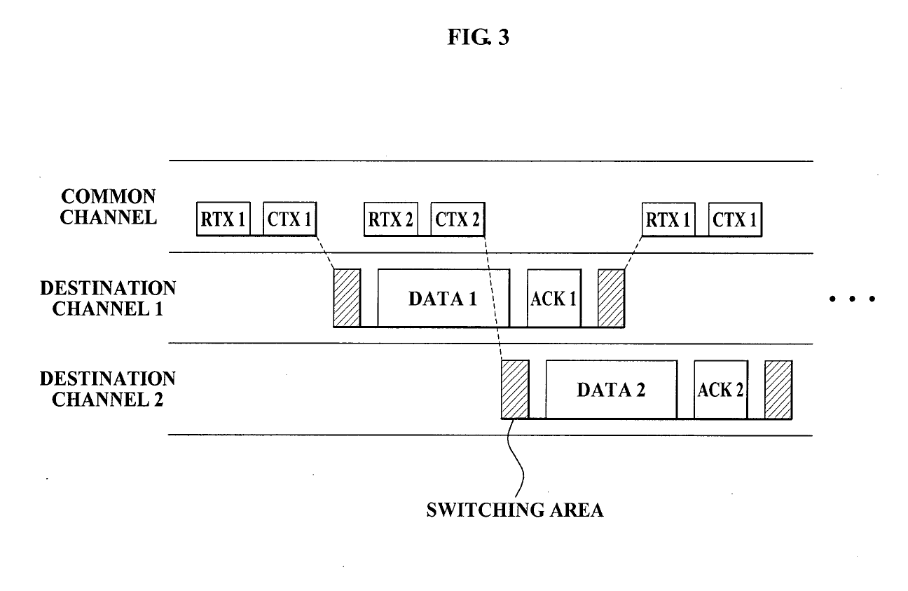

First, a common channel framework (CCF) mechanism which is devised so that MPs having one wireless interface can perform a multi-channel function is applied to the present exemplary embodiment. An operation principle of the applied CCF mechanism is described in greater detail below with reference to FIG. 3.

FIG. 3 is a diagram illustrating an operation principle of a CCF mechanism according to an exemplary embodiment of the present invention. FIG. 3 illustrates an example having a common channel, and destination channels 1 and 2, shown adjacent to one another to illustrate switching between each. A number of RTX/CTX frame exchanges are shown in addition to a number of data and ACK exchanges.

As illustrated in FIG. 3, a transmitting MP and a receiving MP (not shown) according to exemplary embodiments of the present invention exchange an RTX frame and a CTX frame in a common channel. Here, the common channel indicates a channel which all of the MPs in the wireless mesh network can commonly use.

When the exchange of the RTX/CTX frames is completed, the transmitting MP and the receiving MP select another channel for performing the multi-channel function, i.e. a destination channel 1, and switch to the selected destination channel. The transmitting MP and the receiving MP can exchange at least one data frame in the switched destination channel.

When exchange of the data frame is completed, the transmitting MP and the receiving MP switch to the common channel again. Transmission can be simultaneously performed in a plurality of channels via the above process.

The transmitting MP can predetermine, in the common channel, a default threshold value for performing the CCA function with respect to the destination channel. Here, the CCA function preferably corresponds to a function which can measure an energy level with respect to a used channel, and can compare the measured energy level and a threshold value, thereby determining whether the channel is being used. The predetermined default threshold value can be variably determined, depending on for example, whether the frame transmitted from the channel is a preamble or not.

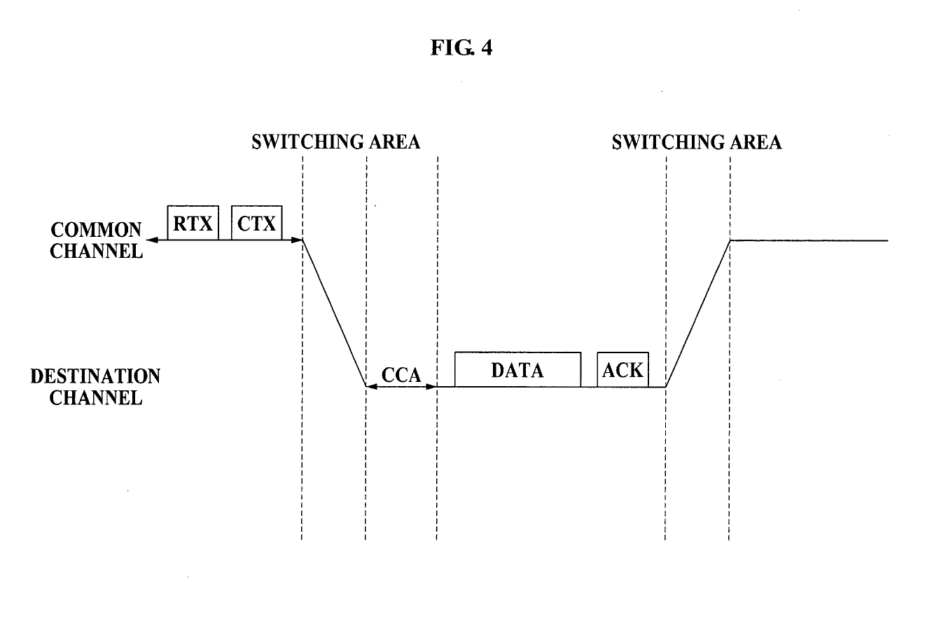

In a manner similar to the description above, an operation principle of performing a CCA function, which can flexibly cope with a hidden node problem by varying a predetermined default threshold value to reflect environmental factors which can affect radio field intensity, is described in greater detail below with reference to FIG. 4.

FIG. 4 is a diagram illustrating an operation principle of performing a CCA function according to an exemplary embodiment of the present invention. FIG. 4 illustrates an example having a common channel and a destination channel shown adjacent to one another to illustrate switching between each. A CCA period, a number of switching periods and a transmission period are shown from left to right to further illustrate the exemplary method performed between channels over time. An exemplary RTX/CTX frame exchange is shown in addition to a data and ACK exchange.

As illustrated in FIGS. 2 and 4, a transmitting MP according to embodiments of the present invention can generate an RTX frame in order to initialize transmission in a common channel, and transmit the generated RTX frame to a receiving MP at step (S210), and receive a CTX frame in response to the RTX frame at step (S220). The CTX frame can comprise information with respect to a destination channel for transmitting a data frame in response to the RTX frame, i.e. a number of the destination channel.

The transmitting MP switches from the common channel to the destination channel, based on the information with respect to the destination channel included in the received CTX frame at step (S230), and the receiving MP can also switch from the common channel to the destination channel.

In this instance, although the transmitting MP and the receiving MP switch from the common channel to the destination channel, ongoing transmission can exist in the destination channel that is switched to when there is a hidden node. Accordingly, a collision can occur in the receiving MP when the data frame is immediately transmitted to the switched destination channel.

The transmitting MP can vary a predetermined default threshold value according to at least one parameter, and determine a variable threshold value to perform the CCA function with respect to the switched destination channel resulting from the varying of the predetermined default threshold value at step (S240). Here, it is preferable that the determined variable threshold value is less than the predetermined default threshold value.

In this instance, the at least one parameter can comprise a distance between nodes, a weather condition, and a geographical feature as primary environmental factors which can affect radio field intensity, but embodiments of the present invention are not limited thereto. Other parameters that affect radio field intensity can be considered, as well as still other parameters that do not necessarily affect radio field intensity, but nevertheless produce desired results.

For example, a variable threshold value can be used for reducing the predetermined default threshold value to a value of up to 6 dB in order to increase a distance, i.e. a radius for detecting a hidden node up to 40%, in a network environment where a weather condition is clear, and/or a geographical feature comprises substantially flat land or water. However, it is typically required to reduce the predetermined default threshold value to a value of greater than 6 dB in a network environment having an adverse weather condition such as torrential rain or heavy snowfalls, and/or a geographical feature in which there are many obstacles, in order to similarly increase a distance, i.e. a radius for detecting a hidden node up to 40%. Therefore, the predetermined default threshold value can be varied to reflect a distance between nodes, weather conditions, geographical features, and so forth, as environmental factors. Accordingly, a determined variable threshold value to perform the CCA function results from the varying of the predetermined default threshold value described above.

The transmitting MP can perform the CCA function in the destination channel at step (S250), based on the determined variable threshold value. Specifically, the transmitting MP can determine whether there is ongoing transmission in the destination channel at step (S260), and can detect energy with respect to the destination channel, and compare the detected energy value with the determined variable threshold value.

As shown in FIG. 4, the transmitting MP can perform the CCA function in the destination channel for a periodic distributed interframe space (DIFS) time period. An interframe space (IFS) is used in order to define a minimum period of time to wait until performing a subsequent operation after sensing that a wireless medium corresponds to an idle state. The IFS is generally divided into a short interframe space (SIFS), a point interframe space (PIFS), a DIFS, and an extended interframe space (EIFS). In particular, the DIFS is defined as in Equation (1) below.

DIFS=((SIFS+2)*slot time) (1)

### In an exemplary embodiment of the present invention, it is preferable that a mobile terminal perform the CCA function for a period of time greater than or equal to the DIFS.

The transmitting MP can determine that there is ongoing transmission in the destination channel when the detected energy value is greater than the determined variable threshold value. The transmitting MP can switch from the destination channel to the common channel, and the receiving MP can also switch from the destination channel to the common channel. Accordingly, the transmitting MP can then set the determined variable threshold value as the predetermined default threshold value at step (S261).

In this instance, the transmitting MP can apply the determined variable threshold value as the predetermined default threshold value. This is done because the hidden node problem can also occur in the common channel when the hidden node problem occurs in the destination channel. Also, the transmitting MP can vary and apply the predetermined default threshold value, based on the determined variable threshold value.

Conversely, the transmitting MP can determine that there is no ongoing transmission in the destination channel when the detected energy value is less than the determined variable threshold value. Therefore, the transmitting MP can generate the data frame to transmit, and transmit the generated data frame via the destination channel to the receiving MP at step (S270).

The receiving MP can receive the data frame, generate the ACK frame in response to the received data frame, and transmit the generated ACK frame to the transmitting MP.

When the transmitting MP receives the ACK frame at step (S280), the transmitting MP can determine that transmission of the data frame is completed. The transmitting MP switches from the destination channel to the common channel at step (S290), and the receiving MP can also switch from the destination channel to the common channel. Accordingly, in this case, the transmitting MP can then set the determined variable threshold value back to the original predetermined default threshold value.

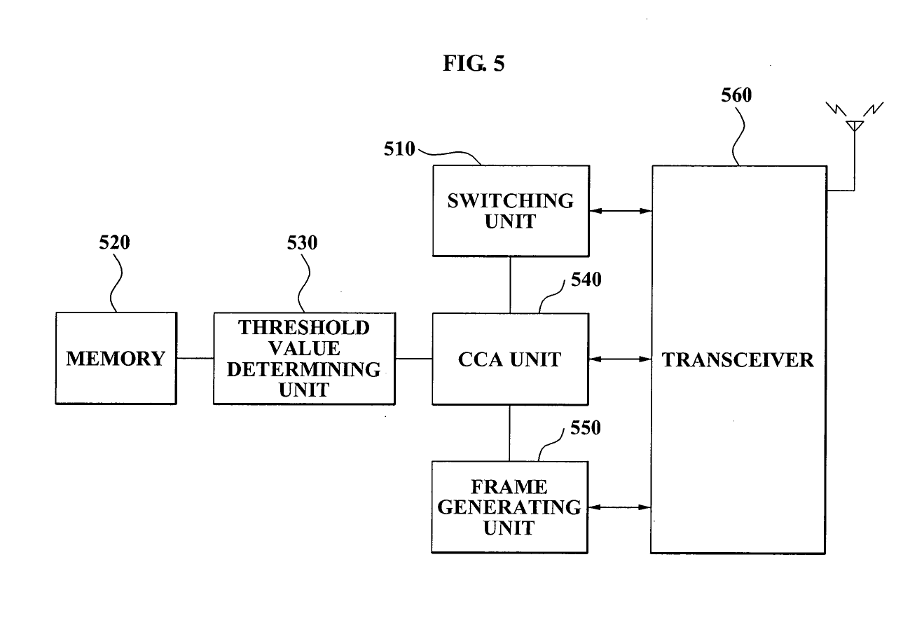

In an exemplary embodiment of the present invention, all of the MPs such as the transmitting MP or the receiving MP, can comprise a base station including an interface device of different types in a wireless environment, an access point, a transceiver, a user equipment (UE), a fixed terminal, and a mobile terminal, but are not limited thereto. A configuration of an exemplary mobile terminal for performing a CCA function in the wireless mesh network is described in greater detail with reference to FIG. 5.

FIG. 5 is a block diagram illustrating a mobile terminal for performing a CCA function in a wireless mesh network according to an exemplary embodiment of the present invention.

As illustrated in FIG. 5, a mobile terminal for performing a CCA function in a wireless mesh network according to exemplary embodiments of the present invention can comprise a switching unit 510, a memory 520, a threshold value determining unit 530, a CCA unit 540, a frame generating unit 550, and a transceiver 560.

The switching unit 510 can switch from a common channel to a destination channel, based on an input CTX frame, and switch from the destination channel to the common channel, based on an input ACK frame. The threshold value determining unit 530 can vary a predetermined default threshold value according to at least one parameter, and determine a variable threshold value to perform the CCA function in the switched destination channel resulting from the varying of the predetermined default threshold value.

The memory 520 can store and manage the default threshold values, the at least one parameter, and the variable threshold values.

The CCA unit 540 can perform the CCA function in the destination channel, based on the determined variable threshold value. The frame generating unit 550 generates a data frame, and the transceiver 560 can transmit, via the destination channel, the data frame input from the frame generating unit 550 when the CCA unit 540 determines that there is no ongoing transmission in the destination channel resulting from the performing of the CCA function. Also, the transceiver 560 can receive the ACK frame in response to the data frame.

In this instance, the frame generating unit 550 can generate a data frame, an RTX frame, a CTX frame, and an ACK frame.

The exemplary embodiments of the present invention can include computer-readable media including program instructions to implement various operations embodied by a computer. The media may also include, alone or in combination with the program instructions, data files, data structures, and the like. The media and program instructions may be those specially designed and constructed for the purposes of the present invention, or they may be of the kind well-known and available to those skilled in the computer software arts. Examples of computer-readable media include magnetic media such as hard disks, floppy disks, and magnetic tape; optical media such as CD ROM disks and DVD; magneto-optical media such as optical disks; and hardware devices that are specially configured to store and perform program instructions, such as read-only memory (ROM), random access memory (RAM), flash memory, and the like. Examples of program instructions include both machine code, such as those produced by a compiler, and files containing higher level code that may be executed by the computer using an interpreter.

According to embodiments of the present invention, a system and method are provided for performing a CCA function in a wireless mesh network, which can determine a variable threshold value reflecting at least one parameter, and perform the CCA function with respect to a destination channel, based on the determined variable threshold value when a common channel is switched to the destination channel, thereby flexibly coping with hidden node problems generated in the wireless mesh network.

While the present invention has been shown and described with reference to certain exemplary embodiments thereof, it will be understood by those skilled in the art that various changes in form and detail may be made therein without departing from the spirit and scope of the invention as defined by the appended claims and their equivalents.

What is claimed is:

1. A method for performing a clear channel assessment (CCA) function to detect a hidden node in a wireless mesh network, the method comprising:
varying a predetermined default threshold value according to at least one parameter, and determining a variable threshold value to perform a CCA function resulting from the varying of the predetermined default threshold value; and
performing the CCA function, based on the determined variable threshold value.

2. The method of claim 1, wherein the at least one parameter comprises a distance between nodes, a weather condition, and a geographical feature which can affect a radio field intensity.

3. The method of claim 1, wherein the determined variable threshold value is less than the predetermined default threshold value to perform the CCA function in a common channel.

4. The method of claim 1, wherein the performing of the CCA function comprises performing the CCA function in a destination channel, based on the determined variable threshold value.

5. The method of claim 4, wherein the performing of the CCA function comprises performing the CCA function in the destination channel for a periodic distributed interframe space (DIFS) time period.

6. The method of claim 4, further comprising:
transmitting at least one data frame via the destination channel when there is no ongoing transmission in the destination channel resulting from the performing of the CCA function; and
switching from the destination channel to a common channel when an acknowledgement (ACK) frame is received in response to the data frame.

7. The method of claim 4, further comprising:
switching from the destination channel to the common channel when there is ongoing transmission in the destination channel resulting from the performing of the CCA function.

8. The method of claim 7, wherein the switching from the destination channel to the common channel comprises setting the determined variable threshold value as the predetermined default threshold value, when the destination channel is switched to the common channel.

9. A computer-readable recording medium having stored thereon instructions for performing a clear channel assessment (CCA) function to detect a hidden node in a wireless mesh network, comprising:
a first set of instructions for controlling a terminal to vary a predetermined default threshold value according to at least one parameter, and determine a variable threshold value to perform a CCA function resulting from the varying of the predetermined default threshold value; and
a second set of instructions for controlling the terminal to perform the CCA function, based on the determined variable threshold value.

10. A mobile terminal for performing a clear channel assessment (CCA) function to detect a hidden node in a wireless mesh network, the mobile terminal comprising:
a threshold value determining unit for varying a predetermined default threshold value according to at least one parameter, and determining a variable threshold value to perform the CCA function resulting from the varying of the predetermined default threshold value; and
a CCA unit for performing the CCA function, based on the determined variable threshold value.

11. The mobile terminal of claim 10, wherein the at least one parameter comprises a distance between nodes, a weather condition, and a geographical feature which can affect a radio field intensity.

12. The mobile terminal of claim 10, wherein the determined variable threshold value is less than the predetermined default threshold value to perform the CCA function in a common channel.

13. The mobile terminal of claim 10, wherein the CCA unit is configured to perform the CCA function in a destination channel, based on the determined variable threshold value.

14. The mobile terminal of claim 13, wherein the CCA unit is configured to perform the CCA function in the destination channel for a periodic distributed interframe space (DIFS) time period.

15. The mobile terminal of claim 13, further comprising:
a transceiver for transmitting at least one data frame via the destination channel when the CCA unit determines that there is no ongoing transmission in the destination channel resulting from the performing of the CCA function; and
a switching unit for switching from the destination channel to a common channel when the transceiver receives an acknowledgement (ACK) frame in response to the data frame.

16. The mobile terminal of claim 15, wherein the switching unit is configured to switch from the destination channel to the common channel when the CCA unit determines that there is ongoing transmission in the destination channel resulting from the performing of the CCA function.

17. The mobile terminal of claim 16, wherein the threshold value determining unit is configured to set the determined variable threshold value as the predetermined default threshold value, when the switching unit switches the destination channel to the common channel.

18. The mobile terminal of claim 10, further comprising:
a memory for storing the predetermined default threshold value, the at least one parameter, and the determined variable threshold value.
